(19) United States
(12) Patent Application Publication
(10) Pub. No.: US 2014/0342126 A1
(43) Pub. Date: Nov. 20, 2014

(54) Massaging Floor Mat with Gel

(71) Applicant: Zinus Inc., San Leandro, CA (US)

(72) Inventor: Suk Kan Oh, Xiamen (CN)

(73) Assignee: Zinus Inc., San Leandro, CA (US)

(21) Appl. No.: 14/281,815

(22) Filed: May 19, 2014

(30) Foreign Application Priority Data
May 17, 2013 (CN) 201310183990.2

(51) Int. Cl. A47G 27/02; B32B 37/14

(52) U.S. Cl. CPC A47G 27/0212; B32B 37/14
USPC 428/160; 156/256; 428/159

(57) ABSTRACT

A massaging floor mat includes a layer of gel that penetrates into the cells of a layer of memory foam. The layer of foam sits on a foundation layer of hard plastic. A plurality of protrusions are distributed over the upper surface of the foundation layer. The protrusions provide a massaging sensation to the user of the mat. The protrusions also hold the layer of foam in place obviating the need to glue the foam to the foundation layer. The gel is spread over the foam as the foam moves along a conveyor belt. The gel is then cured using hot air. The foundation layer is held in place in an indentation of a bottom cover of flexible plastic without using any glue. A top cover is placed over the layer of gel, and the peripheries of the top and bottom covers are attached to each other using high-frequency welding.

### CROSS REFERENCE TO RELATED APPLICATION

This application is based on and hereby claims the benefit under 35 U.S.C. §119 from Chinese Patent Application No. 201310183990.2, filed on May 17, 2013, in China, the contents of which are hereby incorporated by reference. This application is a continuation-in-part of Chinese Application No. 201310183990.2.

### TECHNICAL FIELD

The present invention relates generally to floor mats and, more particularly, to a mat with a gel layer that provides a massaging function.

### BACKGROUND

Besides being used to wipe ones shoes, floor mats also provide cushioning to people who must stand for lengthy periods of time. For example, those who stand in the kitchen while preparing for and cleaning up from meals often experience sore feet. Some store clerks and assembly line workers also stand for extended periods and must endure fatigued feet and legs. Standing on a foam mat can reduce the soreness and fatigue caused by standing for lengthy periods. In addition, small bumps in the mat can produce a massaging sensation that lessens leg fatigue and reduces foot soreness. The foam is typically placed over the massaging bumps to produce a softer massaging sensation and so that the user's feet do not directly feel the hard bumps. The foam layer must be relatively thick, however, to dampen the hard feeling of the bumps. But a user is more likely to trip over a thick floor mat. The thickness of the cushioning material over the hard bumps can be reduced by adding a layer of resilient gel. Manufacturing such gel-based mats, however, can be difficult. The layers of foam and gel tend to shift with usage and when rolled for shipping such that the foam layer moves to one side of the mat interior, while the gel layer moves to the other side. A gel-based floor mat is sought that is efficient to manufacture and whose gel and foam layers do not shift with rolling and usage.

### SUMMARY

A massaging floor mat includes a layer of gel that penetrates into the cells of a layer of foam. The layer of gel and the portion of the gel that penetrates the foam are a contiguous amount of gel so that no separate drops of gel are dispersed in the foam. The layer of foam sits on a foundation layer of hard plastic. A plurality of protrusions are distributed over the upper surface of the foundation layer. The protrusions provide a massaging sensation to the user of the mat. The protrusions also hold the layer of foam in place obviating the need to glue the foam to the foundation layer. The gel is spread over the foam as a sheet of foam moves along a conveyor belt. The gel is then cured using hot air. The foundation layer is held in place in an indentation of a bottom cover of flexible plastic without using any glue. The hard plastic of the foundation layer is less flexible than the flexible plastic of the bottom cover. A top cover is placed over the layer of gel, which remains somewhat sticky. The top cover is then attached to the bottom cover at their peripheral edges using high-frequency welding.

The layer of foam is made of high density (HD) polyurethane foam, visco-elastic polyurethane memory foam or natural latex foam. In one embodiment, the layer of foam is memory foam with a density greater than five pounds per cubic foot and an indentation load deflection greater than twelve. The hard plastic of the foundation layer is made of polyvinyl chloride (PVC), hard rubber, polyurethane, polypropylene, polyethylene, polyvinyl acetate (PVA) or a thermoplastic elastomer (TPE). The flexible plastic of the bottom and top covers is a thermoplastic polyurethane (TPU) membrane laminated onto fabric or polyvinyl chloride (PVC). The plurality of protrusions are shaped as hemispheres or cylinders and are evenly disbursed in a matrix or are arranged in concentric circles on the upper surface of the foundation layer.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is an exploded view of a massaging floor mat that includes both foam and gel.

FIG. 2 is a longitudinal cross-sectional view of the massaging floor mat of FIG. 1.

FIG. 3 is a perspective view of the assembled floor mat of FIG. 1.

FIG. 4 shows the massaging floor mat of FIG. 1 in use.

FIG. 5 is a more detailed perspective view of a cutaway section of the floor mat showing how a portion of the gel flows into the foam cells at the top surface of the foam.

FIG. 6A shows cylindrical protrusions arranged in concentric circles on shallow domes on the upper surface of the foundation layer of the floor mat of FIG. 1.

FIG. 6B shows bumps arranged in concentric circles on double domes on the upper surface of the foundation layer of the floor mat of FIG. 1.

FIG. 7 is a flowchart of steps of a method of manufacturing the massaging floor mat of FIG. 1.

### DETAILED DESCRIPTION

Reference will now be made in detail to some embodiments of the invention, examples of which are illustrated in the accompanying drawings.

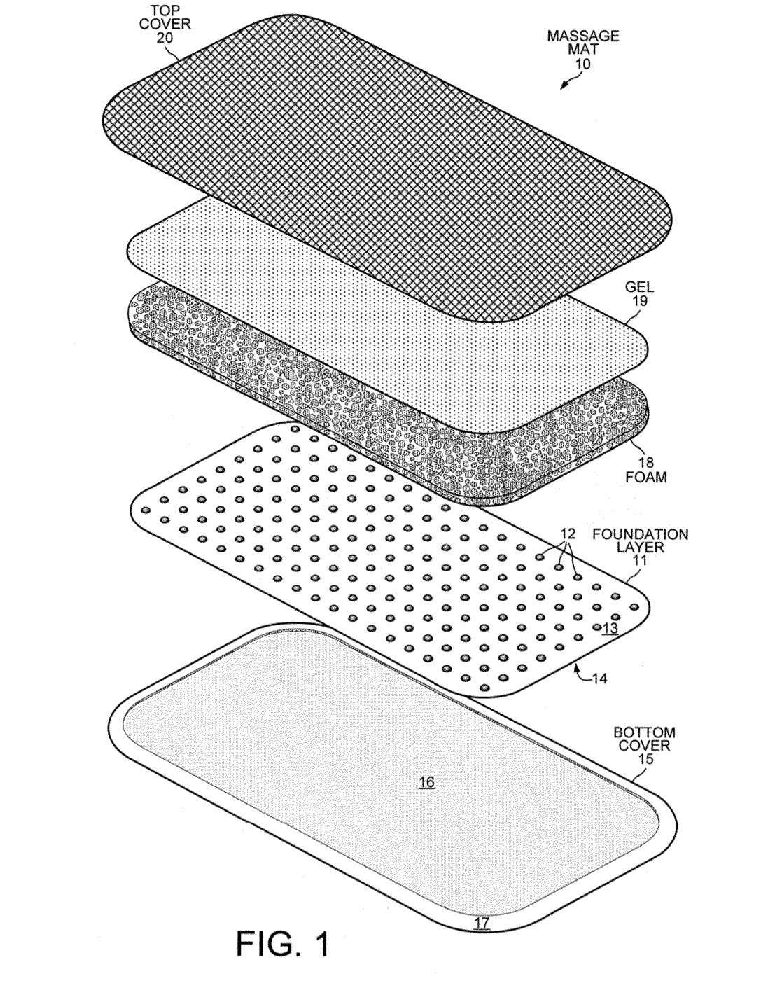

FIG. 1 is an exploded view of a novel massaging floor mat 10 that includes both foam and gel. The massaging function is performed by a hard plastic foundation layer 11 that includes a plurality of bumps 12 protruding from its upper surface 13. The hard plastic of foundation layer 11 can be polyvinyl chloride (PVC), polyurethane, polypropylene, polyethylene, polyvinyl acetate (PVA), a thermoplastic elastomer (TPE) or even hard rubber. In the embodiment of FIG. 1, the protrusions 12 from upper surface 13 are shaped as an evenly distributed matrix of bumps similar to hemispheres. In other embodiments, the protrusions 12 have other shapes, such as cylinders. The protrusions 12 can also be arranged in groups, such as in concentric circles of protrusions.

The lower surface 14 of foundation layer 11 is disposed over a bottom cover 15 of flexible plastic. For example, the flexible plastic is a thermoplastic polyurethane (TPU) membrane laminated onto fabric or a polyvinyl chloride (PVC) sheet. The hard plastic of foundation layer 11 is less flexible than the flexible plastic of bottom cover 15. For example, where both bottom cover 15 and foundation layer 11 are made of polyvinyl chloride (PVC), the PVC of bottom cover 15 is thinner, less rigid and more flexible than the PVC of foundation layer 11. Bottom cover 15 has and indentation 16 into which foundation layer 11 fits. Indentation 16 is surrounded by a peripheral lip 17.

A layer of foam 18 is disposed over foundation layer 11. Foam 18 is high density (HD) polyurethane foam, visco-elastic polyurethane memory foam or natural latex foam. In one embodiment, the layer of foam 18 is made with polyurethane memory foam having a density greater than five pounds per cubic foot and an indentation load deflection (ILD) greater than twelve. Foam with a higher density is not necessarily firmer. It is possible for memory foam to have an ILD greater than twelve and a density less than five pounds per cubic foot. The higher density memory foam is used in massaging floor mat 10 because higher density foam tends to wear better. A lower density foam used in a floor mat would eventually lose its resiliency and remain permanently compressed after years of being stood upon.

A layer of gel 19 is disposed over the layer of foam 18. The gel 19 is an elastomeric silicon-based gel, polyurethane-based gel or a polyether gel. In one embodiment, gel 19 is a blue polyether gel made from a polyether polyol and methylenediphenyl diisocyanate (MDI). The polyether polyol can be purchased from Huizhou YuanAn Industrial Co., Ltd in Guangdong, China, as product number YC-8902M47-A. The MDI can also be purchased from Huizhou YuanAn Industrial Co. Ltd as product number YC-8902M47-B, and is 4,4′-methylenediphenyl diisocyanate. A commercial name of the blue polyether gel is “Vgel”. The gel 19 has a higher heat capacity and thermal conductivity than does the foam 18. The higher thermal conductivity gives the gel a cooler feeling as heat is transferred away from warmer objects that are thermally coupled to the gel, such as the user's feet. Although the exploded view of FIG. 1 shows gel 19 and a separate layer from foam layer 18, the gel and foam and integrally attached to one another. While the gel 19 is still fluid and before the gel sets up, a portion of the gel 19 flows into the cells near the top surface of the foam 18. Thus, a portion of the gel 19 penetrates down into the foam 18, and a portion of the foam 18 penetrates up into the gel 19.

A top cover 20 is disposed over the layer of gel 19. Top cover 20 is made of a flexible plastic, such as a thermoplastic polyurethane (TPU) membrane laminated onto fabric or a polyvinyl chloride (PVC) sheet. Top cover 20 has the same outer dimensions as does bottom cover 15. Top cover 20 is attached to bottom cover 15 at their peripheral edges using high-frequency (ultrasonic) welding. Ultrasonic welding applies high-frequency ultrasonic acoustic vibrations to the two pieces of plastic that are being held together under pressure to create a solid-state weld. The high-frequency welding melts a portion of the peripheral lip 17 of bottom cover 15 into the perimeter of upper cover 20 and seals foundation layer 11 and the combined foam/gel layers 18-19 inside a flexible plastic covering of massage mat 10. By placing top cover 20 over the layer of gel 19 while the gel is still sticky and before the gel sets up, top cover 20 sticks to the layer of gel 19 without using any glue.

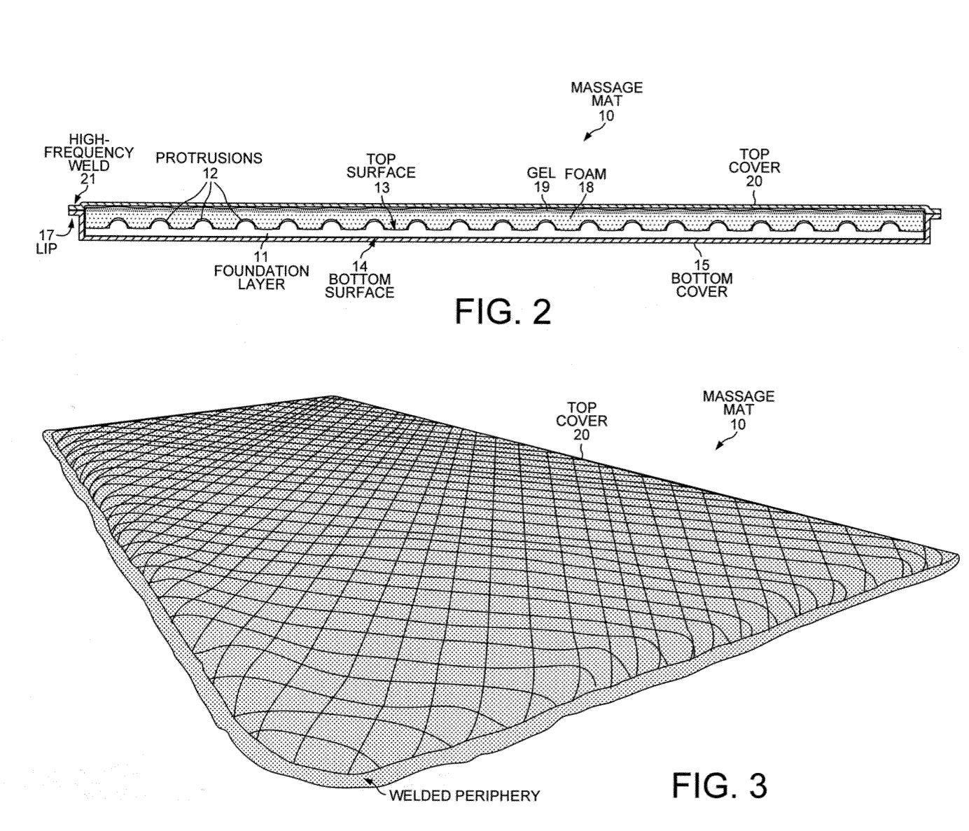

FIG. 2 is a longitudinal cross-sectional view of massaging floor mat 10. FIG. 2 shows that the gel 19 is integrally attached to the foam 18 and forms a single inner resilient member of mat 10. The combined foam/gel layer 18-19 is held in place over foundation layer 11 by the protrusions 12, which prevent the foam and gel from sliding and shifting inside the plastic covering of mat 10. The foam 18 is pressed down and forms a dome over each bump, which prevents the foam from shifting. The foam 18 is more compressed above each bump 12. Foundation layer 11 is held in place within indentation 16 of bottom cover 15. FIG. 2 also shows the location 21 of a high-frequency weld between the periphery of top cover 20 and the lip 17 of bottom cover 15. In this manner, massaging floor mat 10 is made without using any glue to attach the various components to each other.

FIG. 3 is a perspective view of the assembled floor mat 10 of FIG. 1. The welded periphery of top cover 20 is wider in FIG. 3 than shown in FIG. 2 to provide a more durable seal.

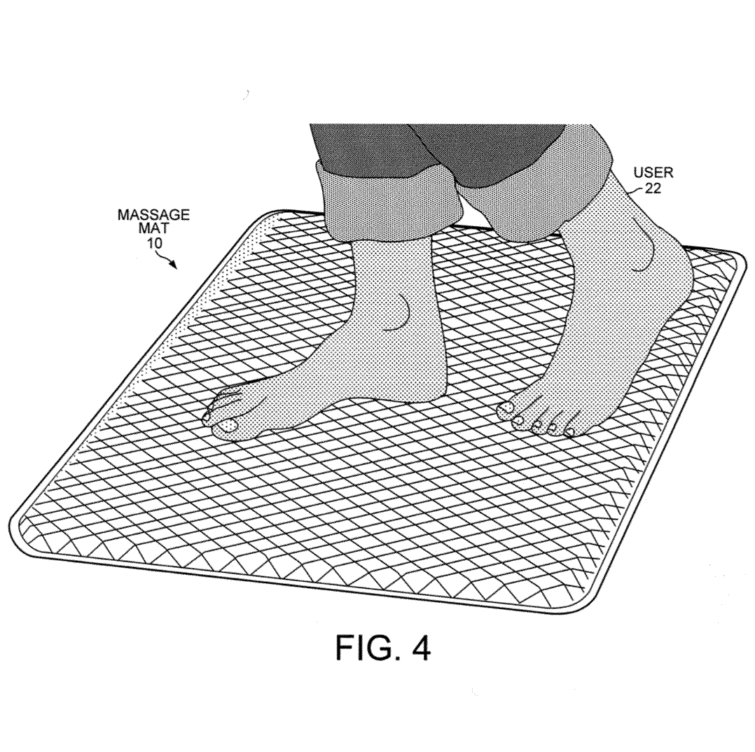

FIG. 4 shows massaging floor mat 10 in use. The feet of a user 22 are standing on mat 10, for example, as user 22 is leaning over the sink of a kitchen.

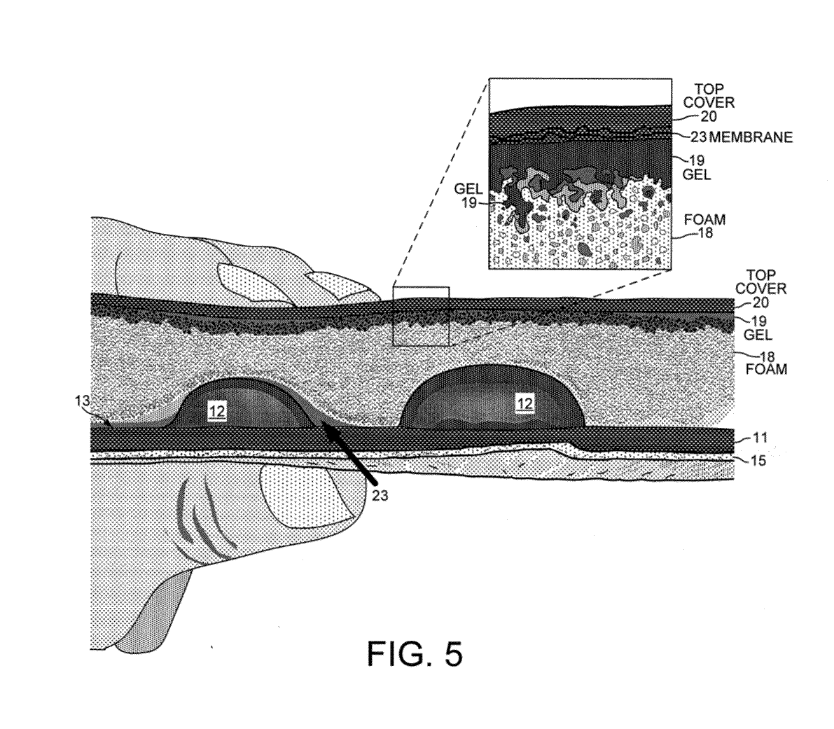

FIG. 5 is a more detailed perspective view of a cutaway section of floor mat 10. FIG. 5 illustrates how a portion of the gel 19 flows into the foam cells located near the top surface of the foam 18. The gel flows down into the foam for so long as there are contiguous open cells. Thus, all of the gel 19 is contiguous; there are no separate drops of gel dispersed throughout the foam. The layer of poured gel 19 is a means for covering foundation layer 11 with both foam and gel such that a portion of the gel 19 penetrates into the foam 18 below, and a portion of the foam 18 penetrates into the gel 19 above.

FIG. 5 also illustrates that the layer of foam 18 is not glued to upper surface 13 of foundation layer 11. As the foam 18 is pressed down over the bumps 12, the bottom surface of the foam does not completely conform to the curvature of the bumps and leaves a small space 23 around the perimeter of some of the bumps. Top cover 20 of the embodiment of FIG. 5 includes thermoplastic polyurethane (TPU) membranes 23 laminated onto fabric. Top cover 20 is placed over gel 19 before the gel has firmed up so that some of the gel can pass into the filaments of the fabric. Thus, no glue is required to attach top cover 20 to the layer of gel 19.

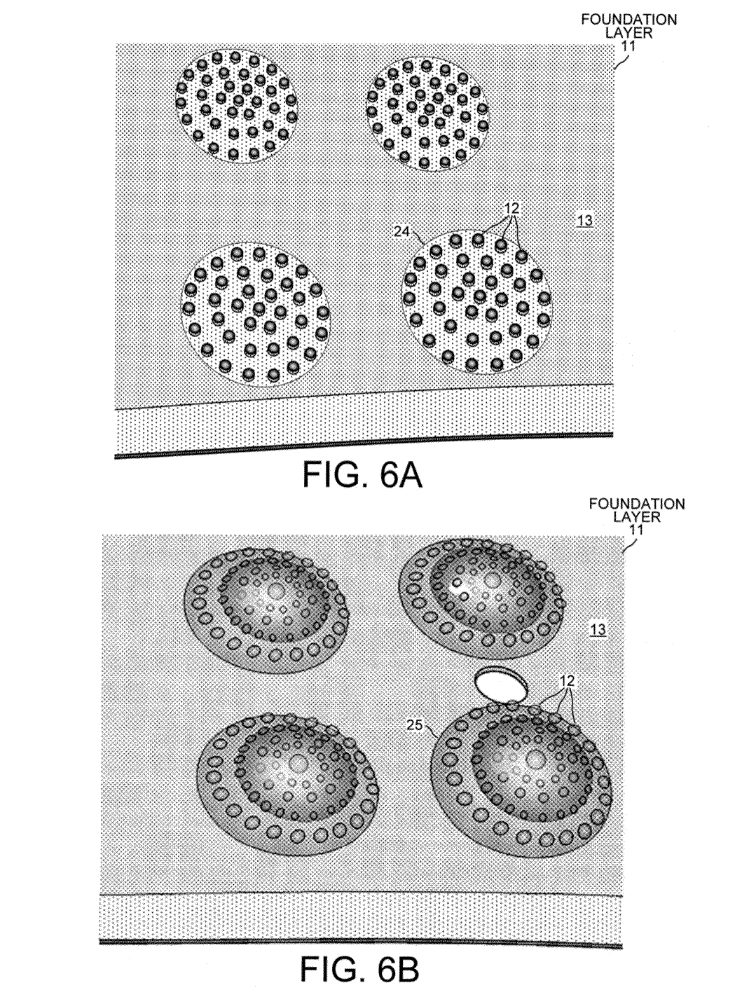

FIGS. 6A-B show alternative ways in which a plurality of protrusions 12 can be distributed over upper surface 13 of foundation layer 11. FIG. 6A shows cylindrical protrusions 12 arranged in concentric circles on shallow domes 24 on upper surface 13 of foundation layer 11. Foundation layer 11 of FIG. 6A is made of molded rubber. FIG. 6B shows bumps 12 arranged in concentric circles on double domes 25 on upper surface 13 of foundation layer 11. Foundation layer 11 of FIG. 6B is made of molded clear polyvinyl chloride (PVC).

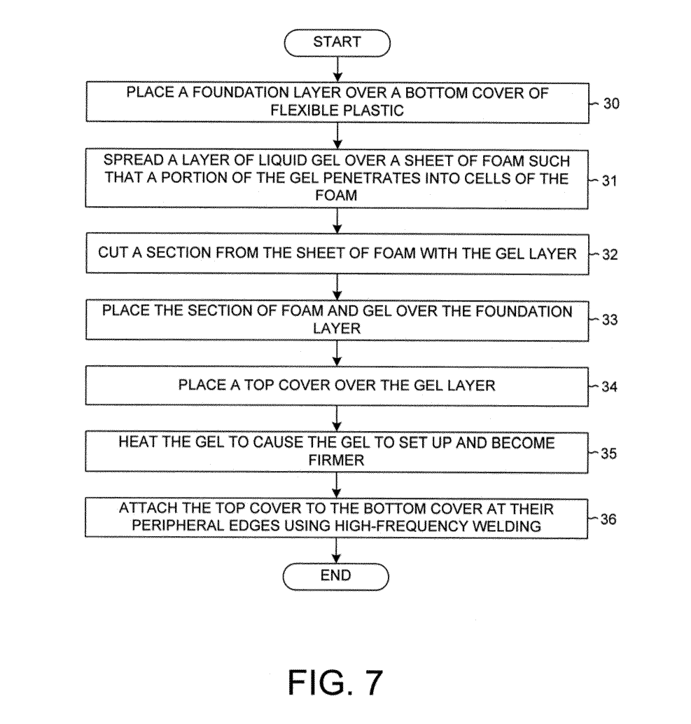

FIG. 7 is a flowchart illustrating steps 30-36 of a method of manufacturing the massaging floor mat 10. In a step 30, foundation layer 11 is placed over bottom cover 15 of flexible plastic. In one embodiment, foundation layer 11 is set into indentation 16, which is surrounded by peripheral lip 17. Foundation layer 11 is held in place within indentation 16 without using any glue.

In step 31, a layer of liquid gel 19 is spread over a sheet of foam 18 such that a portion of the gel penetrates into cells of the foam. In one implementation, a layer of liquid blue polyether gel is spread over the sheet of foam as the sheet of foam is moved by a conveyor belt. The polyether gel is dispensed in a line perpendicular to the motion of the conveyor belt. The foam sheet with the thin layer of gel on the top then travels through a curing chamber in which hot air is blown over the gel so that the gel sets up and becomes firmer. However, the upper surface of the gel is still somewhat sticky. By spreading the layer of gel 19 over sheets of foam, the mat 10 can be more efficiently manufactured in a continuous assembly line process instead of by forming the gel for individual mats in a mold.

In step 32, the sheet of foam 18 with the upper layer of gel 19 is cut into sections that have the dimensions of foundation layer 11. In step 33, a cut section of foam 18 and gel 19 is placed over a foundation layer 11 that is sitting within indentation 16 of bottom cover 15. In step 34, top cover 20 is placed over the layer of gel 19, which is still somewhat sticky. The gel 19 inside the assembled mat is then allowed to cure for many hours. In an optional step 35, the curing process of the gel is sped up by again placing the assembled mat in a curing chamber through which hot air is blown.

Finally in step 36, top cover 20 is attached to bottom cover 15 at their peripheral edges using high-frequency welding. The high-frequency welding melts the upper surface of the peripheral lip 17 of bottom cover 15 to the perimeter of the lower surface upper cover 20. Foundation layer 11, foam 18 and gel 19 are thereby sealed inside the top and bottom covers. The efficient manufacturing method of FIG. 7 does not require a mold for the gel and does not require glue to attach the component layers of the mat to one another. Despite not using glue, the layers of foam and gel do not shift with usage or when the mat is rolled up for shipping.

Although certain specific exemplary embodiments are described above in order to illustrate the invention, the invention is not limited to the specific embodiments. Accordingly, various modifications, adaptations, and combinations of various features of the described embodiments can be practiced without departing from the scope of the invention as set forth in the claims.

What is claimed is:

1. A floor mat comprising:
a bottom cover of flexible plastic;
a foundation layer with an upper surface and a lower surface, wherein the lower surface is disposed over the bottom cover, wherein the foundation layer is made of a second plastic that is less flexible than the flexible plastic, and wherein a plurality of protrusions are distributed over the upper surface;
a layer of foam disposed over the foundation layer;
a layer of gel disposed over the layer of foam, wherein a portion of the gel penetrates into cells of the foam; and
a top cover disposed over the layer of gel.

2. The floor mat of claim 1, wherein the foam is taken from the group consisting of: high density (HD) foam, memory foam and natural latex foam.

3. The floor mat of claim 1, wherein the top cover is made from a material taken from the group consisting of: polyvinyl chloride (PVC) and a thermoplastic polyurethane (TPU) membrane laminated onto fabric.

4. The floor mat of claim 1, wherein the second plastic is taken from the group consisting of: polyvinyl chloride (PVC), rubber, polyurethane, polypropylene, polyethylene, polyvinyl acetate (PVA) and a thermoplastic elastomer (TPE).

5. The floor mat of claim 1, wherein each of the plurality of protrusions is a hemisphere.

6. The floor mat of claim 1, wherein the protrusions are grouped together in concentric rings of protrusions.

7. The floor mat of claim 1, wherein the layer of foam is made with polyurethane memory foam with a density greater than five pounds per cubic foot.

8. The floor mat of claim 1, wherein the foam has an indentation load deflection greater than twelve.

9. The floor mat of claim 1, wherein the layer of gel and the portion of the gel that penetrates the foam are a contiguous amount of gel, and wherein no separate amounts of gel are dispersed throughout the foam.

10. A floor mat comprising:
a bottom cover of flexible plastic;
a foundation layer with an upper surface and a lower surface, wherein the lower surface is disposed over the bottom cover, wherein the foundation layer is made of a second plastic that is less flexible than the flexible plastic, and wherein a plurality of protrusions are distributed over the upper surface;
means for covering the foundation layer with both foam and gel such that a portion of the gel penetrates into the foam and a portion of the foam penetrates into the gel; and
a top cover disposed over the means.

11. The floor mat of claim 10, wherein the foam is polyurethane memory foam having a density greater than five pounds per cubic foot.

12. The floor mat of claim 10, wherein the foam has an indentation load deflection greater than twelve.

13. The floor mat of claim 10, wherein the foam is taken from the group consisting of: high density (HD) foam, memory foam and natural latex foam.

14. The floor mat of claim 10, wherein the second plastic is taken from the group consisting of: polyvinyl chloride (PVC), rubber and polyurethane.

15. A method comprising:
(a) dispersing a layer of liquid gel over a sheet of foam such that a portion of the gel penetrates into cells of the foam;
(b) cutting a section from the sheet of foam with the gel layer;
(c) placing the section over a foundation layer, wherein a plurality of protrusions are distributed over an upper surface of the foundation layer; and
(d) placing a top cover over the gel layer.

16. The method of claim 15, wherein the layer of liquid gel is spread over the sheet of foam as the sheet of foam is moved by a conveyor belt.

17. The method of claim 15, further comprising:
(e) placing the foundation layer over a bottom cover of flexible plastic, wherein the foundation layer is made of a second plastic that is less flexible than the flexible plastic.

18. The method of claim 17, further comprising:
(f) attaching the top cover to the bottom cover at their peripheral edges using high-frequency welding.

19. The method of claim 15, further comprising after (a) and before (b):
(e) heating the gel causing the gel to set up.

20. The method of claim 15, wherein the foam is polyurethane memory foam having a density greater than five pounds per cubic foot.
